(19) United States
(12) Patent Application Publication
(10) Pub. No.: US 2004/0119245 A1
(43) Pub. Date: Jun. 24, 2004

(54) Load member for a face seal

(76) Inventors: Scott A. Thomas, Franklin, NC (US); Mark J. Kiesel, Peoria, IL (US)

Correspondence Address: CATERPILLAR INC., 100 N.E. ADAMS STREET, PATENT DEPT., PEORIA, IL, 616296490

(21) Appl. No.: 10/327,597

(22) Filed: Dec. 20, 2002

(51) Int. Cl. F16J 15/32

(52) U.S. Cl. 277/554

(57) ABSTRACT

A load member is provided for a face seal that reduces the potential for elastomeric set to occur after a period of use. The load member includes a biasing member positioned in a flexible coating.

### TECHNICAL FIELD

The present invention relates to face seal arrangements, and more particularly to a load member of a face seal arrangement.

### BACKGROUND

The present invention has particular application to track rollers, final drives, and other components of work machines. The problem of short bearing life in track rollers and final drive assemblies of work machines is one that has continuously plagued the industry. Such work machines typically operate in environments that are highly destructive to seals and consequently to the underlying bearings.

One approach to this problem is the type seal disclosed in U.S. Pat. No. 5,527,046, which issued Jun. 18, 1996 to Bedford and is assigned to the assignee of the present application. This type of face seal has greatly improved component wear life. However, the load members of such seals are generally made from a resilient material such as an elastomer or rubber and can be damaged during assembly or fail during application. For example, one such problem with prior face seal assemblies involves the deterioration or damage to the load members. The load member can harden or become inflexible due to the repeated cycles of compression (compression set) or simply due to exposure from the corrosive environment in which the work machine operates. When this occurs, the load member may render the force applied to the seal ring ineffective or allow material to pass directly by the load member. Thus, contaminating the sealed and lubricated bearing areas.

The present invention is directed to overcoming one or more of the problems as set forth above.

### SUMMARY OF THE INVENTION

In one aspect of the present invention a load member is provided that is used to apply a force to a seal ring of a face seal assembly. The load member includes a biasing member formed in an annulus. A flexible coating encases the exterior of the biasing member.

### BRIEF DESCRIPTION OF THE DRAWINGS

FIG. 1 is an elevational view, partially in cross-section, of a track roller assembly utilizing a seal arrangement embodying the present invention;

FIG. 2 is an enlarged view of the seal arrangement taken about detail 2 of FIG. 1;

FIG. 3 is an enlarged cross section, taken along line 3-3, of a load member shown in FIG. 2;

FIG. 4 is an alternate embodiment of load member shown in FIG. 2;

and

FIG. 5 is another alternate embodiment of the load member shown in FIG. 2; and

FIG. 6 is yet another alternate embodiment of the load member shown in FIG. 2.

### DETAILED DESCRIPTION

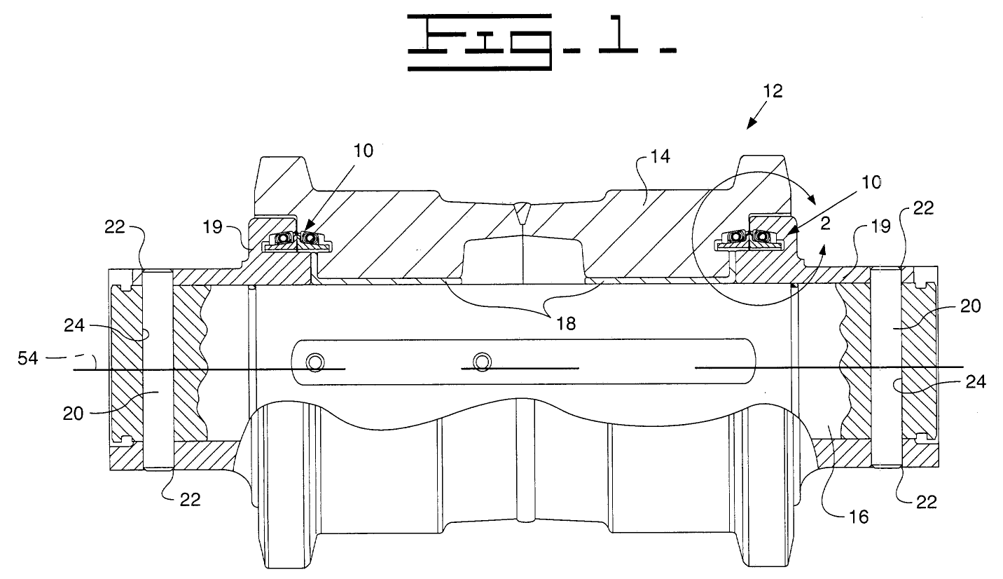

Referring to the drawings and particularly to FIG. 1, illustrates an exemplary environment of use for a seal arrangement shown generally at 10. The environment in this example is a track roller assembly 12 used in a track-type work machine, such as a track-type tractor, excavator, or the like. It should be recognized that other uses of the seal arrangement 10 may be final drives, track chain assemblies, and the like. As well known, the roller assembly 12 is mounted by conventional means between the track roller frame (not shown) and the track (not shown) of the track-type work machine. The roller assembly 12 comprises a conventional roller element 14 rotatably mounted on a shaft 16. A pair of bearing sleeves 18 lines the inner wall of the roller element 12 to provide a durable wear surface. The roller element 12 is confined between a pair of end caps 19 fixed at opposed ends of the shaft 14. Each of the end caps 19 is secured to the shaft 14 by way of a pin 20 extending through apertures 22 in the end caps 19 aligned with a bore 24 through the shaft 14. As a result, the end caps 19 are fixed axially relative to the shaft 14, but a small amount of axial movement or play of the roller element 12 between the end caps 19 is permitted.

With reference to FIGS. 1 and 2, seal arrangement 10, is provided between the roller element 14 and each of the end caps 19. As well known, the seal assemblies 10 are provided to retain lubricant, such as oil, in the vicinity of the bearing surfaces between the roller element 14 and the shaft 16 and also prevent foreign matter from reaching such bearing surfaces. Because each of the seal assemblies 10 may be substantially identical, only one of the seal assemblies 10 is described in further detail herein.

Referring particularly to FIG. 2, the seal assembly 10 comprises a first and second annular seal rings 30,32 each made from metal or other suitable durable, hard material. In the embodiment disclosed herein the first seal ring 30 is positioned juxtaposed the second seal ring 32. However, it should be understood that the first seal ring 30 may be positioned to contact a bushing end face or other abutting member (not shown) so as to perform a similar sealing function. A first load member or toric 34 is positioned between the first seal ring 30 and a bore 36 in the roller element 14 to provide a fluid-tight seal therebetween. A second load member or toric 38 is positioned between the second seal ring 34 and a recess 40 in the end cap 19 and provides a fluid-tight seal therebetween.

The first seal ring 30 has a smooth seal face 42, which confronts and engages a smooth seal face 44 on the second seal ring 32. The plane of engagement between the seal faces 42 and 44 is referred to herein as the “seal plane”. The seal faces 42,44 are maintained in constant sealing engagement by way of load members 34,38. More particularly, first seal ring 30 has an annular ramped surface 46 formed thereon, which is spaced from and confronts an annular ramped surface 48 formed in the bore 36 of the roller element 14. Similarly, the second seal ring 32 has an annular ramped surface 50 formed thereon, which is spaced from and confronts an annular ramped surface 52 formed in the recess 40 of the end cap 19. The length of the ramps 46,48 and 50,52 are selected so that a predetermined compression of the load members 34,38 is maintained, thus providing the desired load on the seal faces 42 and 44.

Ramps 46,48 and ramps 50,52 are angled such that they converge, respectively, in a direction away from the seal plane. More particularly, ramps 46,50 preferably extend at an 8 degree angle relative to an axis of rotation 54 of the roller element 14, and ramps 48,52 preferably extend at a 10 degree angle relative to the axis of rotation 54. Of course, other angles that converge in a direction away from the seal plane could also be used. In this regard, it should be noted that the term “converge” is not used in the sense that ramps 46,48 and ramps 50,52, respectively necessarily physically intersect, but that they would intersect if extended farther away from the seal plane.

As explained above, the converging angle of the ramps 46,48 and ramps 50,52 provide good resistance to external force on the load members 34,38, such as force from mud packing, for example. The disclosed converging angles also provide relatively flat load vs. deflection characteristics so that seal face loading does not change substantially as the seal rings 30,32 move axially relative to the end cap 19.

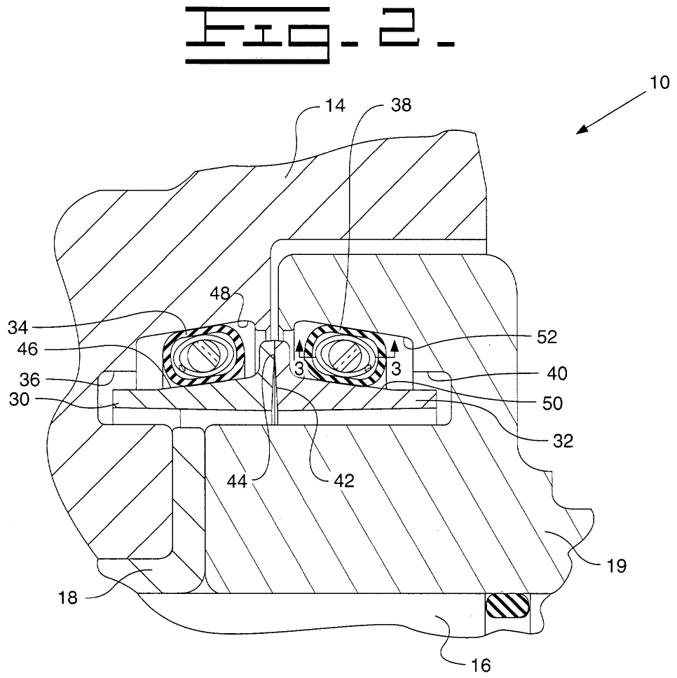

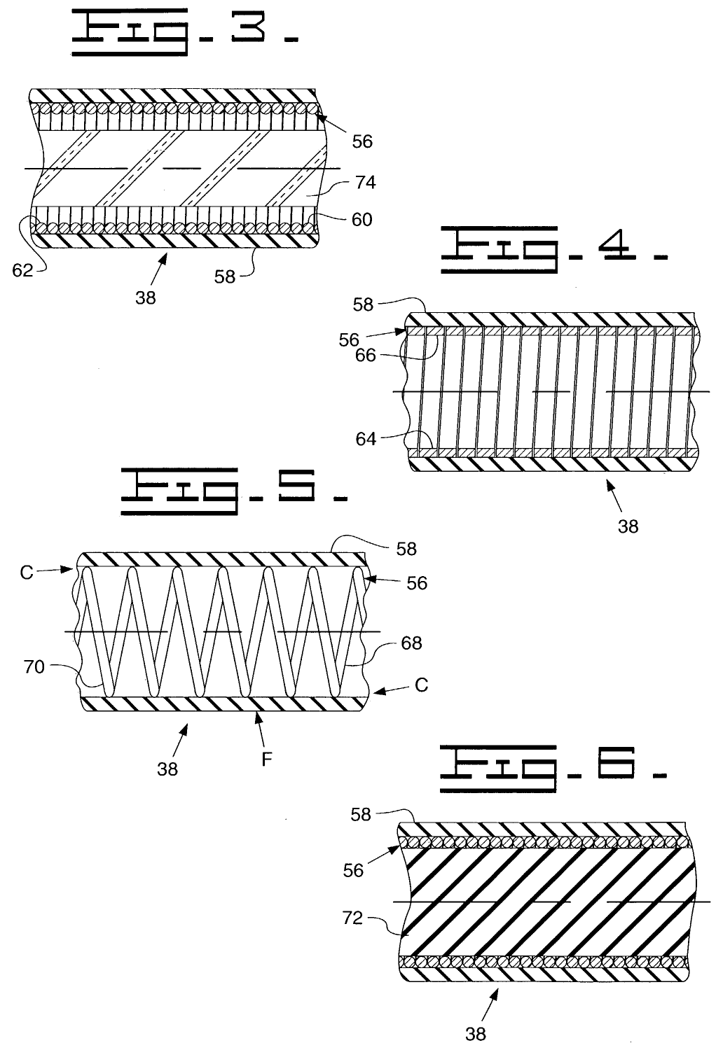

Referring now to FIGS. 3-6, load members 34,38 include a biasing member 56 surrounded by a flexible coating 58. As shown in FIG. 3., the biasing member 56 can be a coil spring 60 constructed of a single strand of a round material 62 wrapped in a generally tight coil. Alternatively, FIG. 4 shows the biasing member 56 as being a coil spring 64 constructed of a single strand of flat material 66 wrapped in a generally tight coil. In another alternative, FIG. 5 shows the biasing member 56 as being a canted coil spring 68. The term canted coil spring 68 as used herein means a coil spring constructed of a single strand of round material 70 with coils that are separated by a predetermined distance. The canted coil spring 66 reacts to a radial force, designated by arrow “F” by bending in the direction of arrows “C” as opposed to compressing or collapsing radially as is the case with the coil springs 60,62 shown in FIGS. 3 and 4. The material 62,66,70, discussed above, used to make coils springs 60,64,68 preferably is a metallic spring wire, however may be a plastic or composite material as well. The flexible coating 58 may be made from any of a number of known elastomeric compounds commonly used to manufacture seals such as rubber compounds. Additionally, FIG. 6 show yet another alternative for the load member 34,38. In this example biasing member 56 shows coil spring 60 completely imbedded in a flexible body 72. The flexible body 72 may be made from any of a number of known elastomeric compounds commonly used to manufacture seals such as rubber compounds.

As shown in FIGS. 2 and 3 the load member 34,38 may also include a support member 74. Support member 74 is positioned inside the biasing member 56 and used to support or limit the amount of compression or deflection of the biasing member 56. Support member 74 may be a cord or rope constructed of fibrous material but could also be an elastomeric cord or even a second smaller coil spring as well.

### Industrial Applicability

In operation the seal arrangement 10 functions to apply a force against the ramps 46,50 of the seal rings 30,32 respectively. As the roller element 14 moves axially between the end caps 19 the load rings 34,38 force the smooth seal face 42 of the first seal ring 30 against the smooth seal face 44 of the second seal ring 32 and visa-verse to retain lubricant and keep contaminants from entering the bore 36 of the roller element 14.

The length of the ramps 46,48 and 50,52 are selected so that a predetermined compression of the load rings 34,38 is maintained, thus providing the desired face load on seal faces 42 and 44. More particularly, the load members 34,38 are compressed upon assembly to a predetermined strain level, which can be substantially maintained throughout the range of movement of the first and second seal ring 30,32 by providing sufficient length to the ramps 46,48 and 50,52. The load members 34,38 have a maximum principle strain level of approximately 31% compression. This compression level is designed to be maintained in the range of 20% to 35%, depending on the deflection of the first and second seal ring 30,32 relative to the end cap 19.

The load member 34,38 of the present design provides additional support in the form of the biasing member 56 so that compressive set of the elastomeric material does not occur. Additionally, the load member 34,38 does not require redesign of existing machine elements such as roller assemblies, final drives and the like.

What is claimed is:

1. A load member used to apply a force to a seal ring of a face seal assembly, said load member comprising:
a biasing member formed in an annulus; and
a flexible coating encasing the exterior of the biasing member.

2. The load member of claim 1 wherein, said biasing member is a coil spring.

3. The load member of claim 2 wherein, said coil spring is a canted spring.

4. The load member of claim 1 including a support member positioned inside said biasing member.

5. The load member of claim 1 wherein, said biasing member is completely imbedded in a flexible body.

6. The load member of claim 1 wherein, said flexible coating is an elastomeric material.

7. A face seal assembly comprising:
at least one seal ring including a ramp portion and a seal face;
a load member being positioned against said ramp portion of said seal ring; and
wherein said load member including a biasing member formed in an annulus, said biasing member having a flexible coating encasing the exterior of the biasing member.

8. The face seal assembly of claim 7 wherein, said biasing member is a coil spring.

9. The face seal assembly of claim 8 wherein, said coil spring is a canted spring.

10. The face seal assembly of claim 7 including a support member positioned inside said biasing member.

11. The face seal assembly of claim 7 wherein, said biasing member is imbedded in a flexible body.
